(19) United States
(12) Patent Application Publication
(10) Pub. No.: US 2015/0120834 A1
(43) Pub. Date: Apr. 30, 2015

(54) METHOD AND SYSTEM FOR REAL TIME COLLABORATION ON A CANVAS

(71) Applicant: Samsung Electronics Co., Ltd., Suwon-si (KR)

(72) Inventors: Sumit MAHESHWARI, Bangalore (IN); Srilakshmi ANNAM, Bangalore (IN); Amit KUMAR, Bangalore (IN); Prashanth Rayapalya Krishnamurthy SHANDILYA, Bangalore (IN); Manas Ranjan MOHANTY, Bangalore (IN); Siba Prasad SAMAL, Bangalore (IN); Niranjan Basagouda PATIL, Bangalore (IN)

(21) Appl. No.: 14/520,552

(22) Filed: Oct. 22, 2014

(30) Foreign Application Priority Data
Oct. 28, 2013 (IN) 4856/CHE/2013
Jan. 8, 2014 (KR) 10-2014-0002158

(51) Int. Cl. H04L 29/06

(52) U.S. Cl. CPC H04L 65/403
USPC 709/204

(57) ABSTRACT

A method and a system for managing collaborative authoring on a canvas are provided. The method includes receiving a request to collaborate on a canvas from a user, determining whether one or more viewports from a plurality of viewports are overlapping or are in vicinity to a viewport associated with the user by a client device and automatically sending a request to a collaboration server to lock at least one object in the viewport if the one or more viewports are overlapping or are in vicinity to the viewport. The method further includes denying a request from a second user to collaborate on the at least one object in the canvas.

### CROSS-REFERENCE TO RELATED APPLICATION(S)

This application claims the benefit under 35 U.S.C. §119(a) of an Indian patent application filed on Oct. 28, 2013 in the Indian Patent Office and assigned Serial number 4856/CHE/2013, and a Korean patent application filed on Jan. 8, 2014 in the Korean Intellectual Property Office and assigned Serial number 10-2014-0002158, the entire disclosure of each of which is hereby incorporated by reference.

### TECHNICAL FIELD

The present disclosure relates to collaboration authoring. More particularly, the present disclosure relates to a method and system for providing partial lockless real time collaboration on a finite or an infinite editable or non-editable medium such as canvas.

### BACKGROUND

A canvas is a multi-dimensional space which allows a user to view, use or author at any co-ordinate. Multiple users can make use of the canvas in real time and hence the authoring can be singular or collaborative. A user can define his area of operation in the canvas. This area can be zoomed in/out to have different perspectives of the canvas. Further the canvas can be dragged by the user to have a view of or modify the elements in the canvas. Thus, the canvas, finite or infinite enables, honing of team efforts and widens its utility.

When a user defines an area of operation, creates a new object, or makes a change to an object on the canvas, or opens/closes his area of operation, a master copy of the canvas needs to be updated at a server and these changes need to be reflected in all client/user devices. In case of collaborative authoring, overhead of managing canvas elements and synchronizing changes made by multiple users' surfaces is of a major concern. There arises a need for concurrency control and locking of the elements on the canvas due to the real time access and modification by multiple users. This further incurs in the additional efforts of conflict resolution. Besides this continuous update of master copy/client copies of the canvas results in frequent and enormous data transfers.

Currently, object locking approach on the canvas sends continuous data to all collaborators through server and hence floods the collaborators with multiple incoming canvas update requests. Also the collaboration effort can become difficult and unmanageable when the users attempt to simultaneously modify the document. Moreover, managing a collaboration effort can be very time consuming. Also the current collaboration tools does not address the problem of handling incoherent view on progress, overwrites, loss of content, and lost time when having to manually assemble content submitted by various users.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system for managing real-time collaboration on a canvas.

Another aspect of the present disclosure is to provide a method and system for enabling collaboration on a canvas with advanced concurrency handling, faster resource update and speedy response from a plurality of collaborators.

Another aspect of the present disclosure is to provide a method and system for reducing client device and server load during collaboration on a canvas.

Another aspect of the present disclosure is to provide a method and system for improving the collaboration server response time to the client devices in real time collaboration on a canvas.

In accordance with an aspect of the present disclosure, a method and system for managing collaboration on a canvas is provided. The method includes receiving a request from a user to collaborate on a canvas, determining by a client device, whether one or more viewports from a plurality of viewports are overlapping or are present in vicinity to a viewport associated with the user and automatically sending a request to lock at least one object in the viewport to a collaboration server if the one or more viewports are overlapping or are present in vicinity to the viewport such that a locked state is applied on the at least one object.

In accordance with another aspect of the present disclosure, a method for managing collaboration on a canvas is provided. The method includes at least one of receiving coordinates associated with each of the plurality of viewports from the collaboration server and computing coordinates associated with the viewport associated with the user.

In accordance with another aspect of the present disclosure, a method of determining whether one or more viewports from the plurality of viewports are overlapping or are present in vicinity to the viewport associated with the user is provided. The method includes determining whether any of the coordinates associated with the plurality of viewports are within a pre-determined threshold distance from the coordinates associated with the viewport and determining the one or more viewports from the plurality of viewports which are overlapping or are present in vicinity to the viewport associated with the user if any of the coordinates associated with the plurality of viewports are within the pre-determined threshold distance.

In accordance with another aspect of the present disclosure, the method further includes sending events associated with collaboration on the at least one object in the viewport to the collaboration server when the one or more viewports from the plurality of viewports are in vicinity to the viewport associated with the user and sending coordinates associated with collaboration on the at least one object in the viewport to the collaboration server when the one or more viewports from the plurality of viewports are in the vicinity to the viewport associated with the user and receiving updates from the collaboration server when the one or more viewports from the plurality of viewports are in the vicinity to the viewport associated with the user.

In accordance with another aspect of the present disclosure, a method of managing collaboration on a canvas is provided. The method includes determining, by a collaboration server, at least one object in the canvas on which collaboration is being performed by a first user of a client device, applying a locked state on the at least one object and denying a request from a second user to collaborate on the at least one object in the canvas.

In accordance with another aspect of the present disclosure, the method of determining the at least one object in the canvas on which collaboration is being performed by the first user of the client device is provided. The method includes receiving a request to apply a locked state on the at least one object from the client device of the first user, determining coordinates of a viewport associated with the first user and determining the at least one object based on the coordinates of the viewport.

In accordance with another aspect of the present disclosure, the method further includes receiving events associated with collaboration on the at least one object from the client device of the first user, determining one or more viewports that are in vicinity of the viewport associated with the first use and sending the events associated with collaboration on the at least one object to one or more client devices of users associated with the one or more viewports.

In accordance with another aspect of the present disclosure, the method includes retrieving one or more changes associated with one or more objects corresponding to at least one viewport when the users shift from one viewport to another viewport and displaying the one or more changes on the current viewport of the user.

In accordance with another aspect of the present disclosure, a system for managing collaboration on a canvas is provided. The system includes a collaboration server and one or more client devices in communication with the collaboration server to provide collaboration on the canvas to a plurality of users. The collaboration server includes a computation module adapted to determine whether at least one object in the canvas on which the collaboration is being performed and a locking module adapted to apply a locking state on the at least one object and deny a request from a second user to collaborate on the at least one object in the canvas.

In accordance with another aspect of the present disclosure, one or more client devices are provided. The client device includes a co-ordinate computation module configured to compute co-ordinates associated with the viewport associated with the user, a collaboration module configured to send co-ordinates associated with collaboration on the at least one object in the viewport to the collaboration server when the one or more viewports from the plurality of viewports are in the vicinity to the viewport associated with the user and a lock request module configured to send a request to lock the at least one object in the viewport to the collaboration server if the one or more viewports are overlapping or are in vicinity to the viewport and if the overlapping viewports or the viewports in the vicinity are within a pre-defined distance.

In accordance with another aspect of the present disclosure, a collaboration server is provided. The collaboration server includes a communication module configured to establish communication with the plurality of client devices, a co-ordinates database configured to store a plurality of co-ordinates associated with each of the plurality of viewports, a co-ordinate computation module configured to compute co-ordinates associated with the viewport of the user, to determine whether any of the coordinates associated with the plurality of viewports are within a pre-determined threshold distance from the coordinates associated with the viewport and to determine the one or more viewports from the plurality of viewports which are overlapping or in vicinity to the viewport associated with the user if any of the coordinates associated with the plurality of viewports are within the pre-determined threshold distance. The server further includes a collaboration module configured to determine at least one object in the canvas on which collaboration is being performed by the first user of a client device.

In accordance with another aspect of the present disclosure, a collaboration server is provided. The collaboration server includes an event notification module configured to receive events associated with collaboration on the at least one object from the client device of the first user and to send the events associated with collaboration on the at least one object to the one or more client devices of users associated with the one or more view ports.

In accordance with another aspect of the present disclosure, the co-ordinate computation module is further configured to determine the co-ordinates of the viewport associated with the first user of the client device and to determine the at least one object based on the co-ordinates of the viewport.

In accordance with another aspect of the present disclosure, the computation module is further configured to store and to retrieve one or more changes associated with one or more objects of the viewport.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a detailed block diagram of a system for providing partial lockless real time collaboration on a canvas according to an embodiment of the present disclosure;

FIG. 2 is a flow diagram illustrating a communication between a collaboration server and a client device of a first user for collaboration on a canvas according to an embodiment of the present disclosure;

FIG. 3 is a flow diagram illustrating a communication between a collaboration server and a client device of a second user for collaboration on a canvas according to an embodiment of the present disclosure;

FIG. 4 is a flow diagram illustrating a signal flow for collaborative authoring between a server and at least two client devices according to an embodiment of the present disclosure; and

FIG. 5 is a flow diagram illustrating a communication between a collaboration server and a client device for managing collaboration on a canvas according to another embodiment of the present disclosure.

Throughout the drawings, it should be noted that like reference numbers are used to depict the same or similar elements, features, and structures.

### DETAILED DESCRIPTION

The various embodiments of the present disclosure relate to a method and system for managing collaborative authoring on a canvas with advanced concurrency handling, faster resource update and speedy response from other collaborators, thereby reducing overhead on the client device and the collaboration server load.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A canvas according to the present disclosure refers to a platform that enables a plurality of users to collaboratively conduct creative work, such as drawing, painting and writing, through their own computers or terminals thereof using communications. The platform may be configured as, for example, Portal Graphics.Net (PGN) OpenCanvas5.5.21, Adobe Photoshop and Adobe Illustrator.

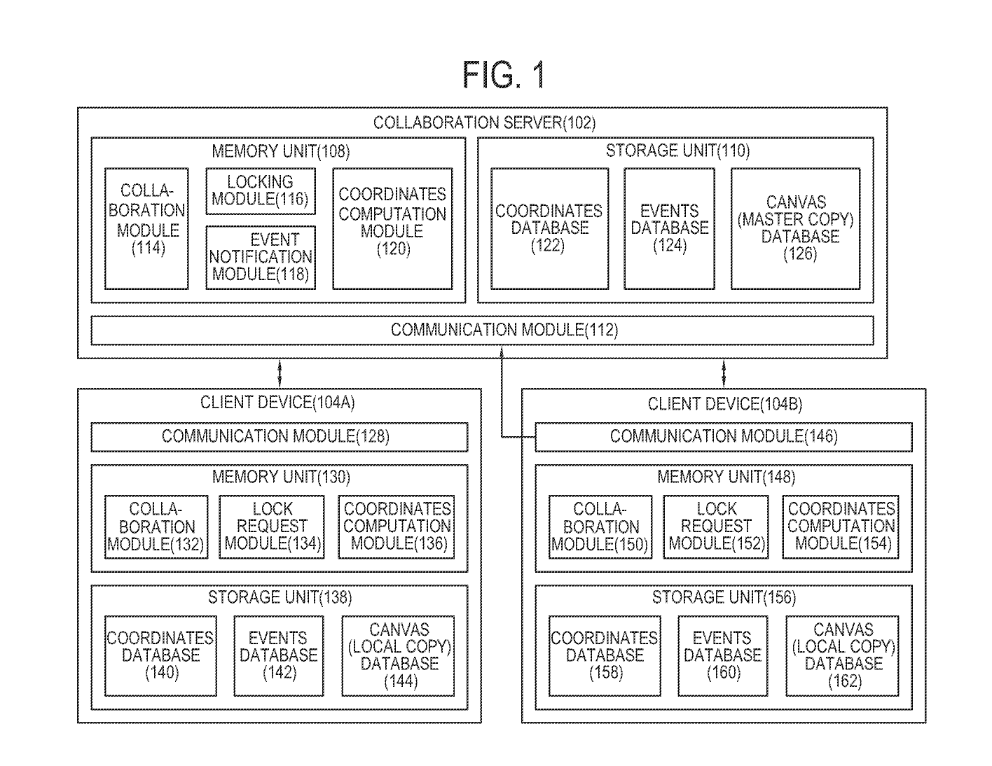

FIG. 1 illustrates a detailed block diagram of a system for partial lockless real time collaboration on a canvas according to an embodiment of the present disclosure.

As illustrated in FIG. 1, the system includes at least two client devices 104A and 104B in communication with a collaboration server 102 for managing collaboration on the canvas. The collaboration server 102 includes a memory unit 108 and a storage unit 110. The memory unit 108 includes a collaboration module 114, a locking module 116, an event notification module 118 and a co-ordinate computation module 120. The collaboration module 114 is adapted to manage the processes of collaboration of a plurality of users on the canvas.

The collaboration module 114 determines the objects in the canvas on which the collaboration is being performed by a first user of a client device and denies a request from a second user to collaborate on the same objects in the canvas. Alternatively, the collaboration module 114 may also determine the objects in the canvas on which the collaboration is being performed by the second user of the client device and deny a request from the first user to collaborate on the same objects in the canvas. The locking module 116 is adapted to lock the object in the viewport based on the usage status. The event notification module 118 is adapted to receive one or more events associated with the collaboration of the objects from the client device of a first user and send these events to one or more client devices of other users associated with the view ports. The co-ordinate computation module 120 is adapted for computing co-ordinates associated with the viewport of the user, determining whether any of the coordinates associated with the plurality of viewports are within a pre-determined threshold distance from the coordinates associated with the viewport and determining the one or more viewports from the plurality of viewports which are overlapping or in vicinity to the viewport associated with the user if any of the coordinates associated with the plurality of viewports are within a pre-determined threshold distance.

The collaboration server 102 further includes a storage unit 110 comprising a co-ordinate database 122, an event database 124 and a canvas database 126. The co-ordinate database 122 is configured for storing a plurality of co-ordinates of one or more viewports associated with the users. The events database 124 stores a plurality of events associated with the collaboration of the objects in the view ports associated with the user. The canvas database 126 is a master database storing the master copy of updated canvas. Further, the collaboration server 102 is provided with a communication module 112 adapted for establishing communication with the corresponding modules in the client devices 104A and 104B.

As illustrated in FIG. 1, each of the client devices 104A and 104B is provided with a communication module 128, 146, a memory unit 130, 148 and a storage unit 138 and 156 respectively. The memory unit 130, 148 in each of the client device 104A and 104B includes a collaboration module 132, 150, a lock request module 134, 152 and a co-ordinate computation module 136, 154. The lock request module 134, 152 is configured for generating a request to the collaboration server 102 to lock an object when one or more viewports are overlapping or are present in the vicinity of the viewport of a collaborating client device. The client storage unit 138, 156 maintains a local copy of the canvas in a local copy database 144, 162 along with a coordinate database 140, 158, and events database 142, 160.

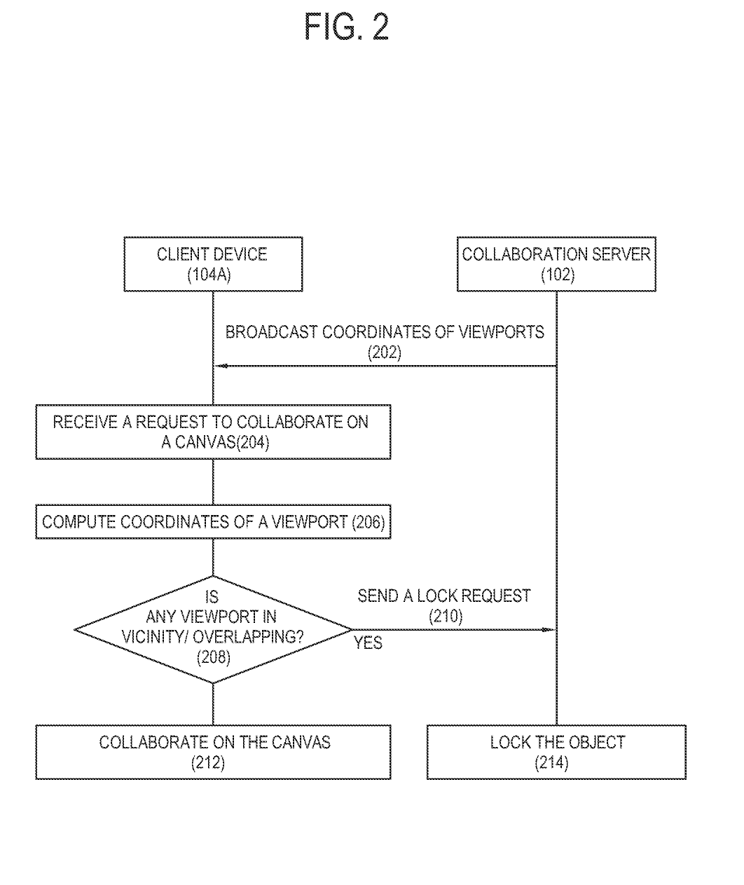

FIG. 2 is a flow diagram illustrating a communication between a collaboration server and a client device of a first user for collaboration on a canvas according to an embodiment of the present disclosure.

The collaboration server 102 may set, as the first user, a user that makes a temporally first request among a plurality of requests for collaboration sent from each client of a plurality of collaborators. Alternatively, as necessary, the collaboration server 102 may set a particular user, for example, a leader of a collaboration group, as the first user. In addition, the collaboration server 102 may determine order of a plurality of collaborators participating in collaboration to perform the collaboration on an object on a canvas. The collaboration server 102 broadcasts the coordinates of all the view ports to the client device 104A associated with a first user at operation 202. The broadcasted co-ordinates are updated in the co-ordinate database 140 of the client device 104A. The client device 104A on receiving a request from a user to collaborate on a canvas at operation 204 computes the co-ordinates of the viewport associated with the user at operation 206. Further the co-ordinate computation module performs a check to find if any of the viewports are overlapping or are present in the vicinity to the viewport associated with the user at operation 208. If any of the viewports are overlapping or are present in the vicinity, then the client device sends a request to lock the object in the viewport it is authoring at operation 210 and locks the object at operation 214. The collaboration server then locks the object for the client device 104A. If any of the viewports are not overlapping or are not present in the vicinity, then the client device allows collaboration on the canvas at operation 212.

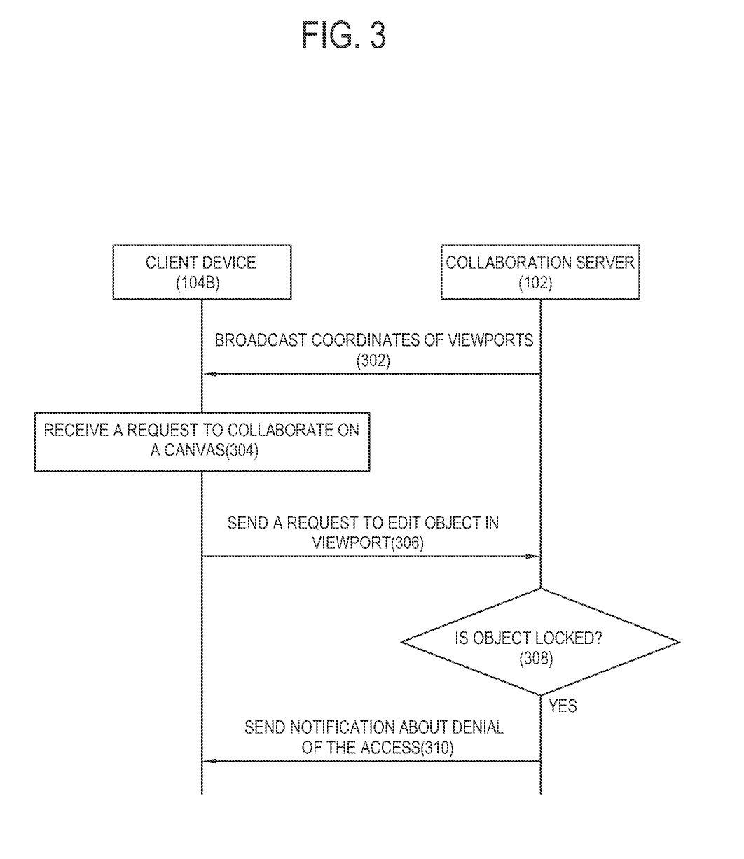

FIG. 3 is a flow diagram illustrating a communication between a collaboration server and a client device of a second user for collaboration on a canvas according to an embodiment of the present disclosure.

The collaboration server 102 broadcasts the coordinates of all the view ports to the client device 104B associated with the second user at operation 302. On receiving a request from the second user to collaborate on the canvas at operation 304, the client device 104B sends a request to edit an object in a view port at operation 306. The collaboration server 102 verifies if the object is locked by another collaborating client device at operation 308. If the object is locked, then the collaboration server 102 sends a notification indicating an access denial for the object in the canvas at operation 310.

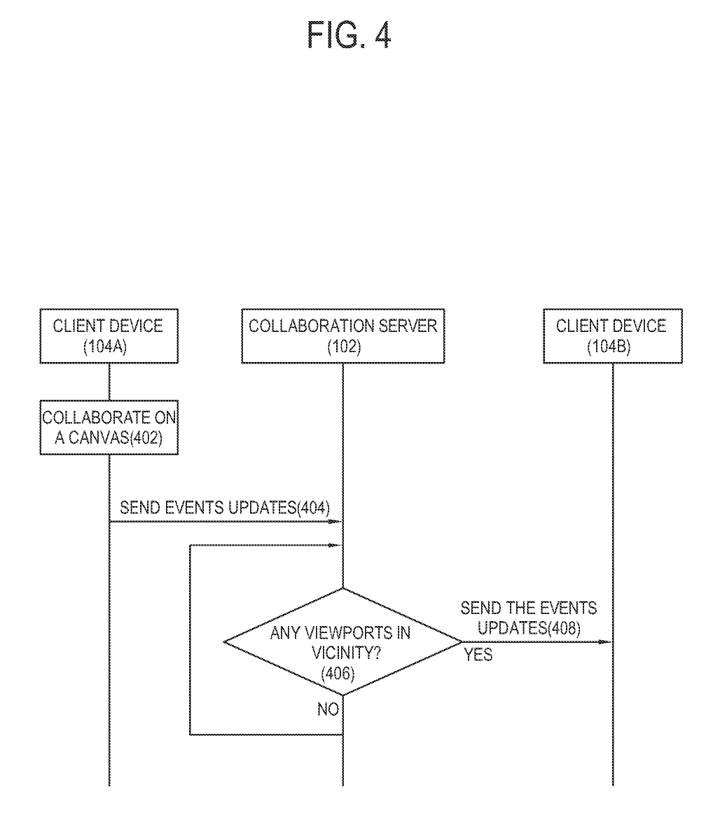

FIG. 4 is a flow diagram illustrating a signal flow for collaborative authoring between a server and at least two client devices according to an embodiment of the present disclosure.

The client device 104A is in collaboration on a canvas at operation 402. The client device 104B send event updates associated with collaboration on the objects in the viewport to the collaboration server 102 periodically at operation 404. The collaboration server 102 verifies if any viewports are in the vicinity of the viewport associated with the user at operation 406. The collaboration server 102 sends periodic updates to the corresponding client device 104B if any viewport are in vicinity to the viewport associated with the second user at operation 408. According to an embodiment herein, the event updates herein includes the effects which are rendered only when the viewport is overlapping or appear in vicinity due to a canvas drag or canvas zoom-out.

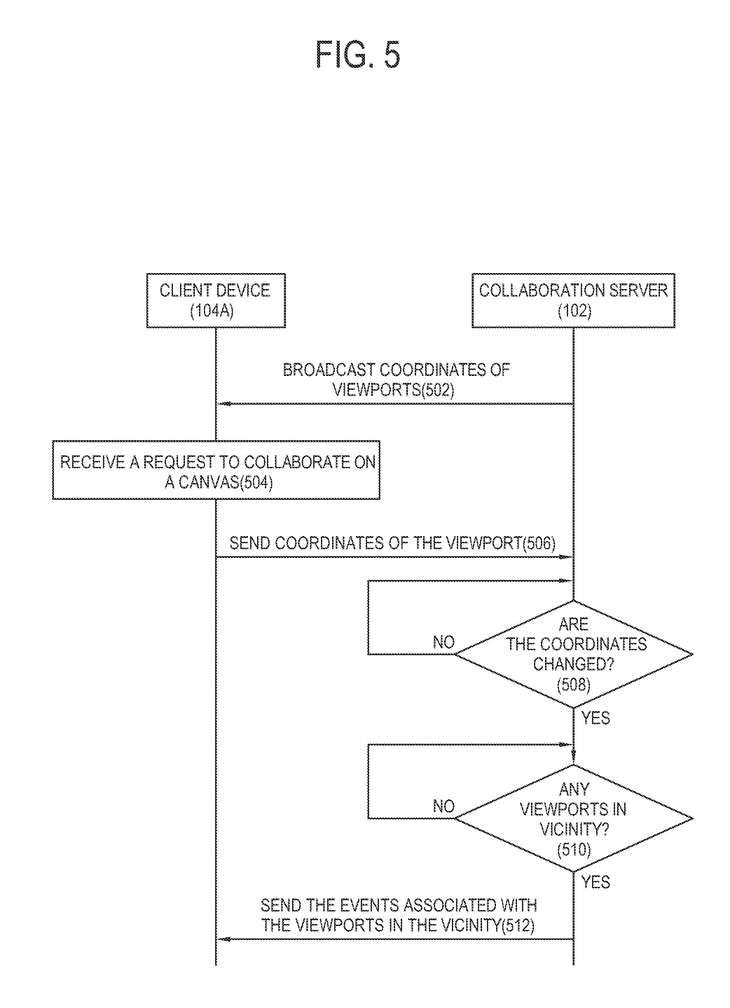

FIG. 5 is a flow diagram illustrating a communication between a collaboration server and a client device for managing collaboration on a canvas according to another embodiment of the present disclosure.

The collaboration server 102 broadcasts the coordinates of all the view ports to the client device 104A associated with a first user at operation 502. The client device 104A on receiving a request from a user to collaborate on the canvas at operation 504 computes the co-ordinates of the viewport and sends the co-ordinates to the collaboration server at operation 506. The collaboration server 102 checks if there is any change in the co-ordinates of the view port at operation 508. If there is a change in the co-ordinates, then the collaboration server 102 checks if any viewport is present in the vicinity to the viewport associated with the user at operation 510. Further the collaboration server 102 sends the events associated with collaboration of the objects associated with the viewport to the client device 104A at operation 512. According to an embodiment herein, the co-ordinates of the view port changes when the viewport of the client device in collaboration on the canvas is zoomed in or zoomed out or the canvas is dragged.

The various embodiments herein includes of a collaboration tool at each client device and a collaboration server. The client devices can communicate with each other using the collaboration server or directly using a peer-to-peer method. According to an embodiment herein each client device maintains coordinates of other client devices current viewport. The coordinates are chosen to be stored in any form, reference or area. For example, a client device can store viewport top-left or coordinates of all other client devices. Being a part of collaboration, the security settings of all the client devices allow other client devices to access their viewports' coordinates. The same co-ordinate map of each client device is stored in the server as well. Each client device broadcasts its viewport co-ordinates to other client devices via the server whenever a user changes the viewport.

The various embodiments of the present disclosure enables the actions done on an object by a first user to be sent in real-time to all the other users only if any other user's viewport are in vicinity or overlapping with that of the first user's viewport. Correspondingly, if a user is performing an action on an object on his viewport and the other users are performing actions on other objects in different viewports, then only end events (actions) are sent to the server and not all the real-time continuous events. This embodiment enables to save the network bandwidth by a great amount and thus a faster collaboration is enabled.

According to an embodiment herein, the client device can filter events based upon the criticality in time and performance to be sent to the collaboration server. Generally events such as insertion of an object or deletion of an object and lock request are sent immediately to the server as it would impact the content, whereas non-critical events like change of color, scale, etc. can be sent after sending critical events.

The various embodiments of the present disclosure enables accessing of an object locked by another person wherein the changes made can be sent to the object owner/content author for approval and negotiation.

The various embodiments herein enable a collaborating device to switch between authoring and presentation mode anytime without affecting other collaborating devices.

The collaboration server according to the various embodiments herein acts as an authorized content storage media for storage and retrieval of authored content and the master copy of the canvas in the collaboration server is updated after a fixed time interval and/or when a new collaborator joins the session.

According to an embodiment herein, the actions performed on the viewport by an user includes, but is not limited to, drag, zoom-in, zoom-out, previous, next, slide-show etc. Here the action of drag implies dragging of a canvas to move in any direction with respect to the viewport, zoom-in and zoom-out implies enlarging or compressing the contents with respect to the viewport, previous or next allow a presenter to navigate content in an orderly manner and slide-show allows a presenter to run content automatically in an orderly or non-orderly manner in a fixed or non-fixed time interval.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of managing collaboration on a canvas, the method comprising:
receiving a request to collaborate on the canvas from a user;
determining whether one or more viewports from a plurality of viewports are overlapping or are in vicinity to a viewport associated with the user by a client device; and
automatically sending a request to a collaboration server to lock at least one object in the viewport if the one or more viewports are overlapping or are in vicinity to the viewport.

2. The method of claim 1, further comprising:
receiving coordinates associated with each of the plurality of viewports from the collaboration server.

3. The method of claim 1, further comprising:
computing coordinates associated with the viewport associated with the user.

4. The method of claim 1, wherein the determining of whether the one or more viewports from the plurality of viewports are overlapping or are in vicinity to the viewport associated with the user comprises:
determining whether any of the coordinates associated with the plurality of viewports are within a pre-determined threshold distance from the coordinates associated with the viewport; and
determining the one or more viewports from the plurality of viewports which are overlapping or are in vicinity to the viewport associated with the user if any of the coordinates associated with the plurality of viewports are within the pre-determined threshold distance.

5. The method of claim 1, further comprising:
sending events associated with collaboration on the at least one object in the viewport to the collaboration server when the one or more viewports from the plurality of viewports are in vicinity to the viewport associated with the user.

6. The method of claim 1, further comprising:
sending coordinates associated with collaboration on the at least one object in the viewport to the collaboration server when the one or more viewports from the plurality of viewports are in the vicinity to the viewport associated with the user.

7. The method of claim 1, further comprising:
receiving updates from the collaboration server when the one or more viewports from the plurality of viewports are in the vicinity to the viewport associated with the user.

8. The method of claim 1, wherein the user is a user of a client device that makes a temporally first request among requests for collaboration on the canvas received from a plurality of client devices.

9. The method of claim 1, wherein the user is a user of a client device set in advance among users of a plurality of client devices.

10. The method of claim 8, further comprising:
receiving events associated with collaboration on the at least one object from the client device of the first user;
determining one or more viewports that are in vicinity of the viewport associated with the first user; and
sending the events associated with the collaboration on the at least one object to one or more client devices of users associated with the one or more viewports.

11. The method of claim 8, further comprising:
retrieving one or more changes associated with one or more objects associated with at least one viewport; and
displaying the one or more changes on one or more view ports, when the one or more users shift from one viewport to another viewport.

12. A system for managing collaboration on a canvas, the system comprising:
one or more client devices configured to provide collaboration on the canvas to a plurality of users; and
a collaboration server,
wherein the collaboration server comprises:
a computation module adapted to determine whether at least one object in the canvas on which the collaboration is being performed; and
a locking module adapted to apply a locking state on the at least one object and deny a request from a second user to collaborate on the at least one object in the canvas.

13. The system of claim 12, wherein the one or more client devices comprises:
a co-ordinate computation module configured to output co-ordinates associated with the viewport associated with the user;
a collaboration module configured to send co-ordinates associated with collaboration on the at least one object in the viewport to the collaboration server when the one or more viewports from the plurality of viewports are in the vicinity to the viewport associated with the user; and
a lock request module configured to send a request to lock the at least one object in the viewport to the collaboration server if the one or more viewports are overlapping or are in vicinity to the viewport and if the overlapping viewports or the viewports in the vicinity are within a pre-defined distance.

14. The system of claim 13, wherein the one or more client devices comprises:
a co-ordinate database configured to store co-ordinates broadcasted by the collaboration server;
an events database configured to store a plurality of events associated with the collaboration of the objects in the view ports associated with the user; and
a local copy database configured to maintain a local copy of the canvas.

15. The system of claim 12, wherein the collaboration server further comprises:
a communication module configured to establish communication with the plurality of client devices;
a co-ordinates database configured to store a plurality of co-ordinates associated with each of the plurality of viewports;
a co-ordinate computation module configured to:
compute co-ordinates associated with the viewport of the user;
determine whether any of the coordinates associated with the plurality of viewports are within a pre-determined threshold distance from the coordinates associated with the viewport; and
determine the one or more viewports from the plurality of viewports which are overlapping or in vicinity to the viewport associated with the user if any of the coordinates associated with the plurality of viewports are within the pre-determined threshold distance; and
a collaboration module configured to determine at least one object in the canvas on which collaboration is being performed by the first user of a client device.

16. The system of claim 15, wherein the collaboration server broadcasts the plurality of co-ordinates of the plurality of viewports to the one or more client devices.

17. The system of claim 12, wherein the collaboration server further comprises:
an event notification module configured to:
receive events associated with collaboration on the at least one object from the client device of the first user; and
send the events associated with collaboration on the at least one object to the one or more client devices of users associated with the one or more view ports.

18. The system of claim 12, wherein the co-ordinate computation module is further configured to:
determine the co-ordinates of the viewport associated with the first user of the client device; and
determine the at least one object based on the co-ordinates of the viewport.

19. The system of claim 12, wherein the computation module is further configured to store and to retrieve one or more changes associated with one or more objects of the viewport.
